(19) United States
(12) Patent Application Publication
(10) Pub. No.: US 2003/0002583 A1
(43) Pub. Date: Jan. 2, 2003

(54) Transcoding of video data streams

(75) Inventor: Jurgen H.T. Geerlings, Valkenswaard (NL)

Correspondence Address: Corporate Patent Counsel, U.S. Philips Corporation, 580 White Plains Road, Tarrytown, NY, 10591, US

(73) Assignee: KONINKLIJKE PHILIPS ELECTRONICS N.V.

(21) Appl. No.: 10/156,387

(22) Filed: May 28, 2002

(30) Foreign Application Priority Data
Jun. 30, 2001 (GB) 0116119.9

(51) Int. Cl. H04N 7/12

(52) U.S. Cl. 375/240.12; 375/240.26

(57) ABSTRACT

MPEG video bitstreams comprising a mixture of I-, P- and B-pictures are transcoded for transfer between apparatuses (110 and 112), using an intermediate bitstream format which comprise essentially I-pictures. Additional information (122) is inserted into the intermediate bitstream in user data fields, to identify which pictures were I-pictures in the original bitstream, and which were not. When transcoding again to IPB format (126), loss of picture quality can be minimised using this knowledge of the original video bitstream structure, in particular by encoding as I-pictures those pictures which were encoded as I-pictures in the original bitstream.

The present invention relates to methods and apparatuses for transcoding digital video bitstreams. The invention finds application in transcoding video streams between different bit rates with particular regard to the MPEG-2 Standard as defined in ITU-T Recommendation H.222.0 | ISO/IEC 13818-1.

The MPEG-2 Standard defined above specifies generic methods for multimedia multiplexing, synchronisation and timebase recovery. The MPEG-2 standard uses a variety of methods to reduce temporal redundancy and improve compression, such as estimating differences in the content between pictures. A notional group of pictures (GOP) typically comprises an intra-coded “I” picture which is coded only using information from itself, predictive “P” coded pictures which are coded using motion vectors based on a preceding I-picture; and bi-directional predicted “B” pictures, which are encoded by prediction from I and/or P pictures before and after them in sequence.

For certain applications it is desirable to change the format of the data streams through the use of a “transcoder” which can convert between bitstream formats. This may be achieved simply through, for example, the use of cascaded MPEG Decoder/Coder arrangements. Such an approach decodes the MPEG stream to obtain a video sequence then re-encodes the sequence according to requirements. However, this approach may lead to an unsatisfactory degradation in picture quality compared to the original encoded video stream, due, for example, to less than optimum re-encoding of the video stream and cumulative quantisation errors.

Known examples of transcoding schemes include WO 00/70877 which discusses converting between MPEG “profiles” and transcodes one format of bitstream of high quality, for example for producing “contribution quality” video, to another format suitable for distribution.

One example of transcoding is when a change in bitrate of the MPEG video stream is required, such as when an MPEG video stream is transmitted over a digital interface to be stored on some medium. In MPEG storage devices the video streams are typically stored at low bit rates using the MPEG I, P and B pictures for efficient storage of the compressed stream. However, not all the video pictures may have been encoded from video pictures of the highest quality. Where the stream is transmitted over a higher bitrate data link (for example IEEE 1394) it is desirable to utilise a different bitstream structure, for example consisting of I-pictures only. At the far side of the link, prior to storage for compression purposes, the stream can be re-coded as IBP picture groups. This scheme may result in pictures originally coded as B- or P-pictures being re-encoded as I-pictures, with subsequent coded B- and P-pictures accumulating compression errors leading to lossy transcoding of the original video stream.

It is an object of the present invention to provide a method of transcoding MPEG video streams which minimises loss of picture quality. It will be understood that the invention is applicable beyond the strict confines of MPEG-2 compliant streams, as similar problems will generally arise when converting similarly structured (video) data streams between any two formats.

The inventors have recognised that to enable high quality transcoding it is possible to use knowledge of the original video bitstream structure to provide optimum picture quality. In order that the transcoder can know about the functional picture structure of the original compressed video stream it is proposed that information describing the functional structure of the original MPEG video stream should be carried in the transmitted stream to be used to create a higher quality transcoded stream.

The invention in a first aspect provides a method for minimising loss in picture quality when transcoding a video bitstream comprising the steps of:

(a) receiving a first bitstream present in a first format which comprises a sequence of encoded pictures;

(b) transcoding said first bitstream to create a second bitstream;

(c) inserting additional information derived from said first bitstream into said second bitstream;

(d) transmitting said second bitstream together with said additional information in a second format;

(e) receiving the second bitstream; and

(f) transcoding the second bitstream into a third bitstream in a third format, using said additional information to define picture structure for said second bitstream.

The first and third data formats may be essentially the same, while the second format is necessary for transmission via the available data channel.

The bitrate of the second bitstream may be higher than that of the first or third bitstreams.

In step (b) the second bitstream may be encoded as intra-coded pictures only.

In step (c) the additional information derived from said first bitstream may include picture sequence structure information, or may include the picture type information of a picture or a sequence of pictures.

In step (d) the additional information may be inserted into a field of the second bitstream defined as a user data field in a standard video data format.

In step (e) the additional information derived from said first bitstream may determine the transcoded format of the third bitstream. In particular, pictures intra-coded in the first bitstream may be preferentially transcoded as intra-coded pictures in the third bitstream.

The method of encoding used for the video bitstreams may be according to the MPEG-2 format or successor formats, as defined by standards bodies.

In step (e) the selection of I-pictures in said first bitstream format may be used to influence the selection of pictures to be encoded as I-pictures in the third bitstream.

The additional information about said first bitstream may be stored in user data fields in the second bitstream. The additional information stored may include the contents of bitstream coded fields specifying the encoded format of the first bitstream.

Examples of the additional information about said first bitstream inserted into the second bitstream includes the presence of the MPEG “group_start_code” and the contents of the “closed_GOP” and “broken_link” fields which can be inserted into a “user_data” field after the “picture_header” field.

Further or alternative information which can be used in the method and inserted into the stream includes the contents of the MPEG “picture_coding_type” field inserted in a “user_data” field after the “picture_header” field. Formats other than MPEG will provide analogous information fields which can be used to implement the invention.

The steps (a)-(d) may be performed in a first video processing apparatus, while steps (e) and (f) are performed in a second apparatus connected to the first apparatus for the transmission of said second bitstream.

Accordingly, the invention further provides a method of transcoding a first bitstream in a first format to a second bitstream in a second format for transmission over a digital interface, the transcoding means including means for embedding in said second bitstream additional information regarding the structure of said first bitstream in said first format.

The bitrate of said second bitstream may be higher than the bitrate of said first bitstream.

The additional information may specify which pictures encoded as intra-coded pictures in said second bitstream were not encoded as intra-coded pictures in said first bitstream.

Similarly, the invention yet further provides a method of transcoding a second bitstream in a second format to a third bitstream in a third format wherein said second bitstream in a second format is received over a digital interface and transcoded into said third bitstream in said third format using information regarding the structure of a first bitstream in a first format embedded in said second bitstream.

The bitrate of said second bitstream may be higher than the bitrate of said third bitstream.

Where the third bitstream includes both inter-coded and intra-coded pictures, the additional information may be used to control which pictures, encoded as intra-coded pictures in said second bitstream, should be encoded as intra-coded pictures in said third bitstream in preference to other pictures also encoded as intra-coded pictures in said second bitstream.

The method may further comprise recording of said third bitstream on a record carrier implementing any of the methods set forth above.

The method of transcoding herein described may be implemented using software or hardware solutions only, or a combination of both.

In another aspect of the invention there is provided an electronic signal representing a video stream encoded in an intermediate format as a series of intra-coded pictures, the signal further comprising encoded additional historical functional information indicating the picture type and picture sequence from which said intra-coded pictures were derived. Said electronic signal may comprise historical functional information about said video stream structure including picture sequence and picture type information that would otherwise be lost in a transcoding process.

Said historical functional information may be used to control which pictures, previously encoded as intra-coded pictures in said second bitstream, should be encoded in the future as intra-coded pictures bitstream in preference to other pictures also encoded as intra-coded pictures in said second bitstream.

The invention further provides apparatus comprising means specifically adapted for implementing any of the methods according to the invention set forth above, as defined in the attached claims, to which reference should now be made, and the disclosure of which is comprised herein by reference. The method of transcoding herein described may be implemented using software or hardware solutions only, or a combination of both.

The system further provides means adapted to recording said transcoded video stream in said third format upon suitable record carrier means.

Embodiments of the invention will now be described, by way of example only, by reference to the accompanying drawings, in which:

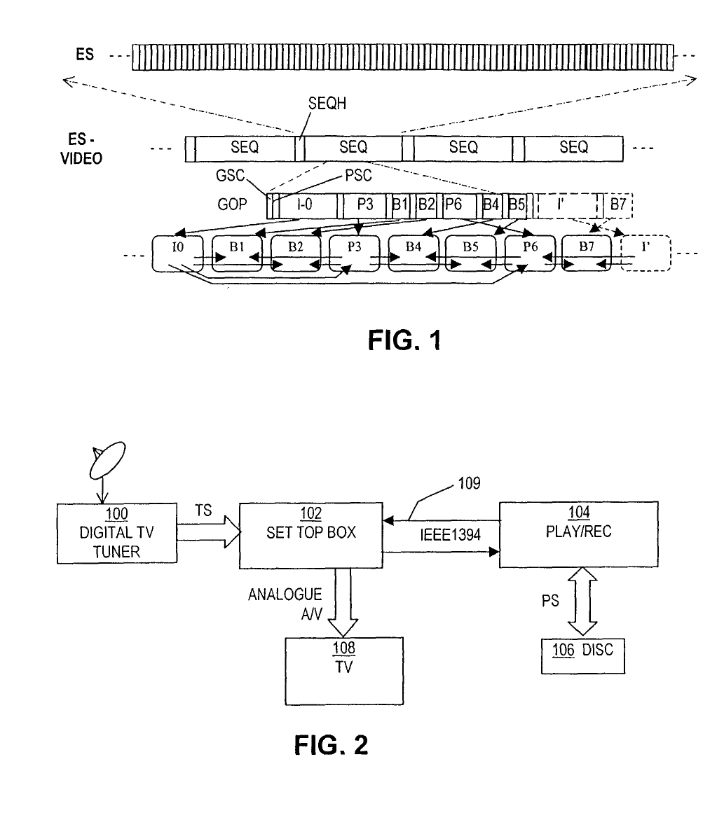

FIG. 1 illustrates the format of picture sequences in a MPEG-compliant bitstream;

FIG. 2 illustrates an example digital video entertainment system in which an embodiment of the invention is applied;

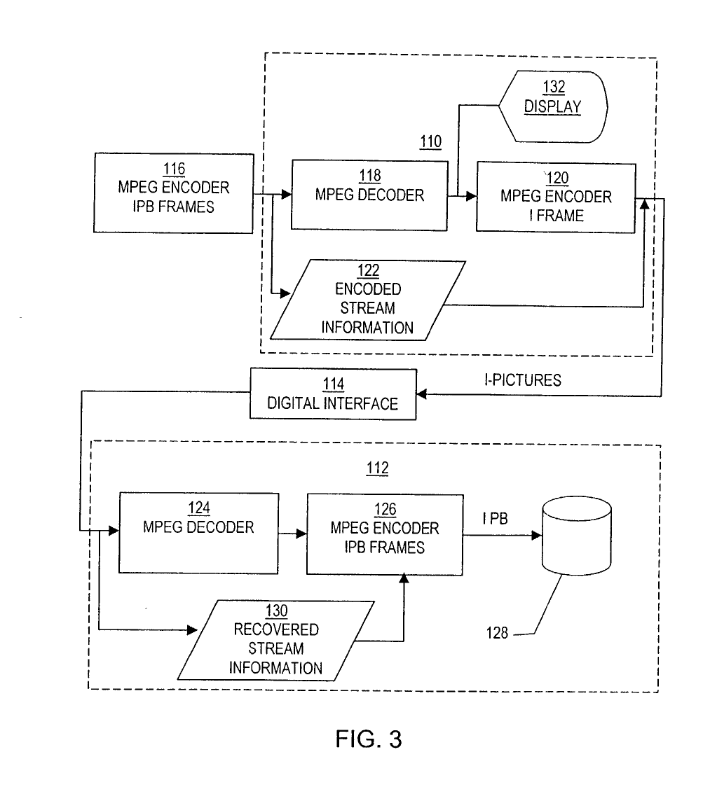

FIG. 3 illustrates in more detail an example of a transcoding process in the digital video system of FIG. 2; and

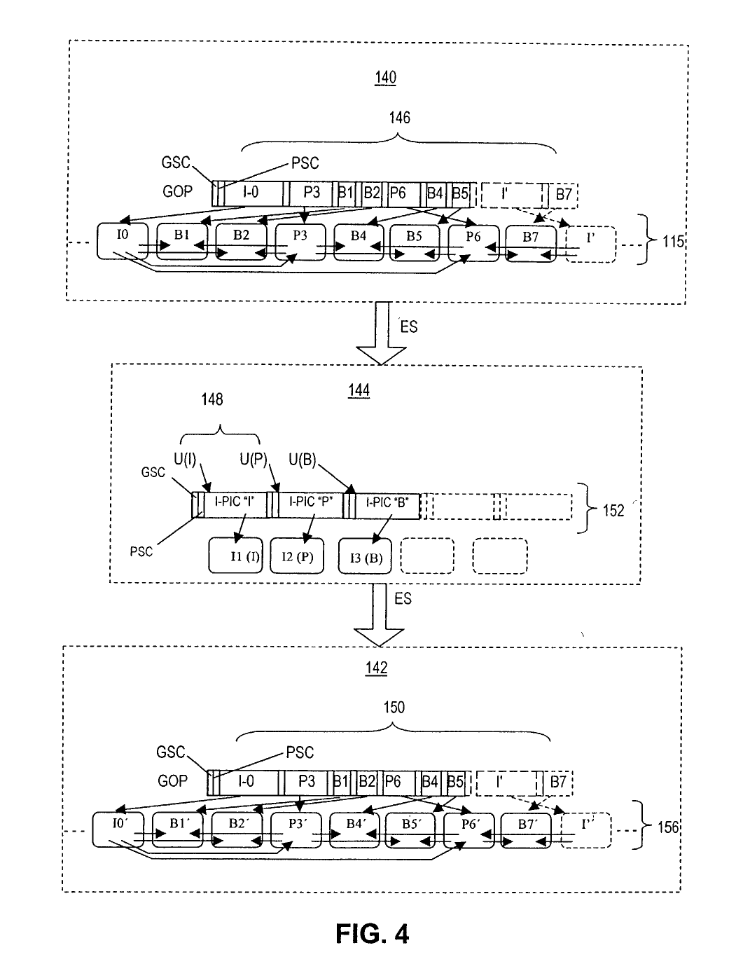

FIG. 4 illustrates structures in the transcoding process of FIG. 3.

FIG. 1 illustrates the format of compressed video data in an MPEG elementary stream (ES) format showing key features and structures of the bitstream with regard to picture sequence coding and display order. In practice, the video data is packetised and interleaved with audio and other data streams. The details of this transport mechanism are not relevant for an understanding of the present invention, and will not be discussed further. Suffice it to say, within a transport stream, the payload of successive packets having a certain stream forms a continuous elementary stream of data shown schematically as ES in FIG. 1. In the case of a video elementary stream ES-VIDEO, various picture sequences of video clips SEQ are present, each including at its start a sequence header SEQH. Various parameters of the decoder including quantisation matrices, buffer sizes and the like are specified in the sequence header. Accordingly, correct playback of the video stream can only be achieved by starting the decoder at the location of a sequence header. Within the data for each sequence are one or more “access units” of the video data, each corresponding to a picture. Each picture is preceded by a picture start code PSC. A group of pictures GOP may be preceded by a group start code GSC, all following a particular sequence header SEQH.

As is well known, pictures in MPEG-2 and other modern digital formats are generally encoded by reference to one another so as to reduce temporal redundancy and achieve data compression. Motion compensation provides an estimate of the content of one picture from the content already decoded for a neighbouring picture or pictures. Therefore a group of pictures GOP may comprise: an intra-coded “I” picture, which is coded without reference to other pictures; “P” (predictive) coded pictures which are coded using motion vectors based on a preceding I-picture; and bi-directional predicted “B” pictures, which are encoded by prediction from I and/or P-pictures before and after them in sequence. The amount of data required for a B picture is less than that required for a P picture, which in turn is less than that required for an I picture. On the other hand, since the P and B pictures are encoded only with reference to other pictures, it is only the I pictures which provide an actual entry point for starting playback of a given sequence.

It will be noted that the GOP data, the I and P pictures are encoded in the bitstream before the corresponding B pictures, and then re-ordered after decoding so as to achieve the correct presentation order. This ensures that the necessary neighbouring reference frames have been decoded before data arrives for a productively encoded B or P frame. Thus, to present the sequence of frames I0, B1, B2, I8 in the example of FIG. 1, the images are encoded in the order I0, P3, B1, B2, P6, B4, B5, I8, B7 and so on.

FIG. 2 illustrates an example home digital video entertainment system, including a digital TV tuner 100, a set top box 102 for decoding digital video signals, controlling access to pay channels and so forth, a digital video playback and recording device 104 such as a DVD or future DVR recorder, and the storage medium itself (recordable DVD disc 106). In this example, a conventional TV set 108 is used in this configuration for displaying pictures from a satellite, cable or terrestrial broadcast, or from a recording on disc 106. Between the digital tuner 100 and the set top box 102, MPEG transport stream (TS) format signals carry a number of digital TV channels, some of which may be scrambled for decoding with special conditional access (pay TV) arrangements. The standard digital broadcast formats, for example DVB, ATSC and B4SB, are specific applications within the MPEG-2 transport stream format.

Set top box 102 also decodes a desired programme from within the transport stream TS, to provide analogue audio and video signals to the TV set 108. These analogue signals can of course be recorded by a conventional video recorder (VCR). On the other hand, for maximum quality and functionality, the direct digital-to-digital recorder such as DVD or DVR recorder 104 is preferred. This is connected to the set top box 102 via a digital interface 109 such as IEEE1394 (“Firewire”). This carries a “partial TS” in which the selected programme is separated from the larger TS multiplex, and presented still within the TS format. On the other hand, to take advantage of the improved directory structure and random-access features, the player/recorder 104 is arranged to convert the TS format into “programme stream” (PS) format for recording on the disc 106, and to convert PS format streams recorded on disc 106 into partial TS format for playback via the digital interface 109 and set top box 102 on the TV 108.

FIG. 3 illustrates an example of a transcoding process implemented in a digital video system such as that illustrated in FIG. 2. In this generalised example there is a transmitter 110, receiver 112 and digital interface 114. Additionally there is a source encoder 116 supplying MPEG encoded IPB frames, such as digital TV tuner 100 of FIG. 2. The function of transmitter 110 may be implemented for example by the set top box 102 of FIG. 2 and comprises an MPEG decoder 118 and MPEG encoder 120. The receiver 112 in this example is analogous to the recorder 104 of FIG. 2 and comprises MPEG decoder 124, MPEG encoder 126 and storage device 128. Additional encoding means 122 are provided in transmitter 110 to analyse and encode video bitstream information into an intermediary video bitstream: similarly additional decoding means 130 is provided in the receiver 112 to extract the same encoded stream information from the intermediary video bitstream. Display means 132 of transmitter 110 may be the television of FIG. 2 and storage medium 128 in the receiver 112 a recordable DVD disc, magnetic hard disc, or other recordable medium.

In this example the video bitstream may be encoded in either PS or TS format, and the format of the bitstream need not remain the same across the whole system. The final video bitstream will be recorded onto storage medium 128 as a PS format bitstream, for example.

In MPEG storage devices such as those depicted in FIGS. 1 and 2 the video streams are typically stored at low bit rates using MPEG I, P and B-pictures. However, where the stream is transmitted over a higher bit rate data link, for example standard IEEE 1394 (Firewire), it is expected that in real-time a different bitstream structure will be used, typically comprising I-pictures only.

In the example of FIG. 3 a video stream is originally encoded as IPB pictures at a first bitrate by source encoder 116. It will be appreciated that source encoder 116 may be a recording or broadcast encoder external to the consumer system depicted in FIG. 2. The video bitstream is wanted as I-pictures only for transmission over digital interface 114. In order to do this the originally encoded video stream is decoded by MPEG decoder 118 and re-encoded by MPEG encoder 120 as I-pictures only. The I-pictures only MPEG bitstream is transmitted across digital interface 114 to receiver 112 where the I-pictures are transcoded to a lower bitrate as a series of IPB pictures decoded by decoder 124 and recoded by encoder 126, for storage on medium 128. The differences between TS and PS formats are not material to the present invention, and need not be discussed in detail. Examples of transcoding between PS and TS formats are presented in our co-pending International patent applications numbers WO 01/50761 and WO 01/50773.

In MPEG coding/decoding the coded order, or order of the coded pictures in the bitstream, is the order in which a decoder receives them in the bitstream and reconstructs them. The display order, or presentation order of the reconstructed pictures at the output of the decoding process, need not be the same as the coded order. The MPEG standard defines rules by which pictures are re-ordered. For example, when the sequence contains no coded B-pictures, the coded order is the same as the display order. When B-pictures are present in the sequence, re-ordering is performed according to certain rules. For example, if the current picture in coded order is a B-picture, the output picture is the picture reconstructed from that B-picture. If the current picture in coded order is a I-picture or P-picture, the output picture is the picture reconstructed from the previous I-picture or P-picture if one exists. If none exists, at the start of the sequence, no picture is output. The picture reconstructed from the final I-picture or P-picture is output immediately after the picture reconstructed when the last coded picture in the sequence was removed from the video buffering verifier (VBV) buffer.

MPEG encoder 126 will not reproduce a lossless copy of the video stream as produced by encoder 116 and decoded by MPEG decoder 118. However, since there is no need for compression at this stage in the process, MPEG encoder 120 encodes all picture types as I-pictures only, including B- and P-pictures. In this way quality loss should be minimal. Subsequently, after transmission across digital interface 114 the I-picture only stream will be decoded into a picture stream and re-encoded by encoder 126 into a sequence of I P B pictures for recording at 128.

It will be seen from the above that the complete process for making a recording from a digital TV broadcast in the digital home video system of FIGS. 2 and 3 involves receiving (from 116) a first bitstream encoded in a first format, transcoding it (at 118 and 120) into a second bitstream in a second format and finally transcoding the second bitstream (at 124, 126) into a third bitstream in a third format for recording at 128. The first bitstream may be referred to as the source data stream and the third bitstream may be referred to as a destination data stream, while the second bitstream is an intermediate data stream of a form compatible with the interface 114. In order to view the recoding via display 132, it can be appreciated that further decoding and re-coding into the intermediate stream format will be required, before final decoding and display.

The recoding processes at 120 and 126 will each introduce a loss of quality in the final video picture, as it is replayed from medium 128 at a later date. P and B pictures are particularly of lower quality, due to their greater compression. The loss of quality is exacerbated in cases of where a frame encoded as a P or B picture in the source stream is recorded as an I-picture in the destination stream. The resulting I picture will be used as a reference for the decoding of neighbouring pictures in the playback of the destination stream at a later date, leading to a widespread degradation in the final playback image.

To improve the picture quality of the playback video in the novel system proposed here, there is provided at the transmitter 110 side of the system means 122 for retaining information from the source bitstream which would normally be discarded by decoder 118, and inserting this information into the intermediate datastream when it is encoded by encoder 120. Correspondingly, there is provided on the receiver 112 side of the system means 130 for recovering the information inserted into the intermediate data stream by means 122. This recovered information about the originally coded bitstream can be used to ensure that MPEG encoder 126 encodes a video bitstream of optimum quality, as will be described.

The means 122 for analysing and encoding the additional information required for the tracking of the I-picture across the transcoding process can be implemented as an integral component of the set top box 102 of FIG. 2, for example as part of the MPEG coded hardware or software. Similarly the means 130 for recovering the additional information can be implemented as an integral component of the player/recorder 104.

FIG. 4 illustrates an example of the transcoding of a source video bitstream 140 from a first format to a destination video bitstream 142 in a third format by way of intermediate video bitstream 144 in a second format. In this example the first and third formats are IPB sequences and the second format a sequence of I-pictures only, such as the case when a MPEG video bitstream is transmitted over digital interface 114. Video streams 140, 142, 144 are shown at a level of detail showing only the GOP 146, 148, 150 structure and resultant picture presentation order 150, 152, 154. As detailed elsewhere the GOP includes group start codes and picture start codes GSC and PSC coding.

In the scheme shown and also referring to FIG. 3, a sequence of GOPs 146 is analysed before the stage of decoding a first video stream by decoder 118 in FIG. 3. The required Information regarding the original stream structure is analysed for later use by receiver 112. In this example, the fields containing information identifying the beginning of a group of pictures, and the picture type (I-, B- or P-picture) is identified and acquired, as is detailed later.

The decoded video bitstream is now encoded by encoder 120 into bitstream 144 comprising a sequence of I-pictures 148 only, for transmission across digital interface 114. Each of the encoded I-pictures in this bitstream be derived from and may correspond to I-, P- or B-pictures of the original video stream 140. At the stage of encoding the I-pictures the information acquired by means 122 regarding the original I-picture sequences of the first video bitstream 140 is inserted into I-picture only bitstream 144.

An MPEG encoded video stream has a well defined video bitstream syntax which lists such parameters as start code values, video sequence information, header information and user data, amongst others. Combined with the MPEG video stream semantics, legal bitstreams may then be produced. By interrogation of the coding data it is possible to extract data which describes the structure of the encoded video stream. Additionally, user defined data fields can be specified. Once the required information about the original video stream has been acquired then it can be transmitted with the intermediary stream to the receiver 112. This can be done by inserting the information into other fields in the encoded video Elementary Stream.

It is possible, therefore to track and store the order of the I, P and B-pictures within a GOP. This can be done by tracking the location and content of the fields “group_start code” and “picture_coding_type” fields in the MPEG bitstream. The field group_start_code identifies the beginning of a group of pictures header. The field picture_coding_type identifies whether a picture is an intra-coded picture(I), predictive-coded picture(P) or bi-directionally predictive-coded picture(B). The content of these fields can be acquired and transmitted in order to track which of the newly encoded pictures, which are now all coded as I-pictures only, were originally I-pictures in the source video stream.

The information acquired from the original bitstream 140 can be stored within specified user defined fields “user data”, here indicated by U(I), U(P) and U(B) in the I-picture only bitstream 144. The MPEG standard can specify exact locations of such fields in the video bitstream. One possible location to store the required information is the user_data field of the picture_header field. Of course, the information may be stored within other suitable data fields. User data fields are defined by MPEG in the group_of pictures_header, for example. However, the structure of the second bitstream in the present example means that there will generally be too few group_of pictures_header fields.

The newly encoded I-picture only stream has been received and decoded, and the original stream structure extracted therefrom by means 130. MPEG decoder 124 receives the I-picture only bitstream and decodes to produce a video bitstream which is subsequently re-encoded by encoder 126 to produce third bitstream 142. The additional information (122) acquired about the structure of the original bitstream 140 now can be used to ensure that only I-pictures from original bitstream 140 are used to encode I-pictures in the final bitstream 142, thus ensuring optimal quality of the encoded bitstream 142. This optimal quality bitstream can now be recorded on storage medium 128.

While the policy of always encoding I pictures from I-pictures is clearly the ideal in this embodiment, there may of course be other factors which cause the encoder to deviate from this rule on occasion. In particular, bitrate constraints, editing points and the like may require the encoder to encode I-pictures from frames originally encoded as P- or B-pictures. Provided that the encoder exhibits a preference for encoding I-pictures from I-pictures, however, degradation of quality can be minimised.

Those skilled in the art will appreciate that the embodiments described above are presented by way of example only, and that many further modifications and variations are possible within the spirit and scope of the invention. For example, the method of transcoding herein described may be implemented using software or hardware solutions only, or a combination of both. Also, MPEG-2 standard is cited as only one example of a compressed video format. Many other formats including proprietary video streaming formats and alternate versions of MPEG such as MPEG-4 have the same coding principles, and the skilled person will readily see how the principles of the present invention can be applied there also.

Finally, it will be understood that the home video system illustrated in FIG. 2 is only one example system in which the invention may be applied, and the transfer of video from MPEG source 116 to recording medium 128 is only one example application. Other components and configurations are equally possible, and the roles of each of the apparatus in the claimed process may be different times, without departing from the scope of the invention as claimed.

1. A method for minimising loss in picture quality when transcoding a video bitstream, the method comprising the steps of:
(a) receiving a first bitstream present in a first format which comprises a sequence of encoded pictures;
(b) transcoding said first bitstream to create a second bitstream;
(c) inserting additional information derived from said first bitstream into said second bitstream;
(d) transmitting said second bitstream together with said additional information in a second format;
(e) receiving the second bitstream; and
(f) transcoding the second bitstream into a third bitstream in a third format, using said additional information to define picture structure for said second bitstream.

2. A method as claimed in claim 1, wherein the bitrate of the second bitstream is higher than that of the first or third bitstreams.

3. A method as claimed in claim 1, wherein in step (b) the second bitstream is encoded as intra-coded pictures only.

4. A method as claimed in claim 1, wherein in step (c) the additional information derived from said first bitstream relates to picture sequence structure information.

5. A method as claimed in claim 1, wherein said additional information further includes the picture type information of a picture or a sequence of pictures.

6. A method as claimed in claim 1, wherein in step (d) the additional information is inserted into a field of the second bitstream defined as a user data field in a standard video data format.

7. A method as claimed in claim 1, wherein in step (e) pictures intra-coded in the first bitstream are preferentially transcoded as intra-coded pictures in the third bitstream.

8. A method as claimed in claim 1, wherein the additional information about said first bitstream inserted into the second bitstream includes the MPEG “group_start_code” and the contents of the “closed_gop” and “broken_link” fields which are inserted into a “user_data” field after the “picture_header” field.

9. A method as claimed in claim 1, wherein further information inserted into the stream includes the contents of the MPEG “picture_coding_type” field inserted in a “user data” field after the “picture_header” field.

10. A method as claimed in claim 1, wherein the steps (a)-(d) are performed in a first video processing apparatus, while steps (e) and (f) are performed in a second apparatus connected to the first apparatus for the transmission of said second bitstream.

11. A method of transcoding a first bitstream in a first format to a second bitstream in a second format for transmission over a digital interface, the transcoding method including the step of embedding in said second bitstream additional information regarding the structure of said first bitstream in said first format.

12. A method as claimed in claim 11 wherein the bitrate of said second bitstream is higher than the bitrate of said first bitstream.

13. A method as claimed in claim 11, wherein the additional information specifies which pictures encoded as intra-coded pictures in said second bitstream were not encoded as intra-coded pictures in said first bitstream.

14. A method of transcoding a second bitstream in a second format to a third bitstream in a third format wherein said second bitstream in a second format is received over a digital interface and transcoded into said third bitstream in said third format using information embedded in said second bitstream, said information defining the structure of a first bitstream in a first format from which the second bitstream was previously derived.

15. A method as claimed in claim 14 wherein the bitrate of said second bitstream is higher than the bitrate of said third bitstream.

16. A method as claimed in claim 14, wherein the third bitstream includes both inter-coded and intra-coded pictures and wherein the additional information is used to control which pictures, encoded as intra-coded pictures in said second bitstream, should be encoded as intra-coded pictures in said third bitstream in preference to other pictures also encoded as intra-coded pictures in said second bitstream.

17. A method as claimed in claim 1, wherein the method further comprises recording of said third bitstream on a record carrier implementing any of the methods set forth above.

18. An electronic signal representing a video stream encoded in an intermediate format as a series of intra-coded pictures, the signal further comprising encoded additional historical functional information indicating the picture type and picture sequence from which said intra-coded pictures were derived.

19. An electronic signal as claimed in claim 18 wherein the electronic signal encodes said historical functional information in user data fields of a standard video data format.

20. An apparatus comprising means specifically adapted for implementing any of the methods according to any preceding claim.

21. An apparatus for minimising loss in picture quality when transcoding a video bitstream, the apparatus comprising:
(a) means for receiving a first bitstream present in a first format which comprises a sequence of encoded pictures;
(b) means for first transcoding said first bitstream to create a second bitstream;
(c) means for inserting additional information derived from said first bitstream into said second bitstream;
(d) means for transmitting said second bitstream together with said additional information in a second format;
(e) means for receiving the second bitstream; and
(f) means for transcoding the second bitstream into a third bitstream in a third format, using said additional information to define picture structure for said second bitstream.

22. An apparatus as claimed in claim 21 wherein said means for first transcoding encodes said second bitstream as intra-coded pictures only.

23. An apparatus as claimed in claim 21 wherein the additional information inserted by said means for inserting additional information is derived from said first bitstream related to picture sequence structure information.

24. An apparatus as claimed in claim 21, wherein said additional information further includes the picture type information of a picture or a sequence of pictures.

25. An apparatus as claimed in claim 21, wherein said means for transmitting said second bitstream inserts the additional information into a field of the second bitstream defined as a user data field in a standard video data format.

26. An apparatus as claimed in claim 21, wherein said means for transcoding the second bitstream preferentially transcodes pictures intra-coded in the first bitstream as intra-coded pictures in the third bitstream.

27. An apparatus as claimed in claim 21, wherein the additional information about said first bitstream inserted into the second bitstream includes the MPEG “group_start_code” and the contents of the “closed_gop” and “broken_link” fields which are inserted into a “user_data” field after the “picture_header” field.

28. An apparatus as claimed in claim 21, wherein further information inserted into the stream includes the contents of the MPEG “picture_coding type” field inserted in a “user_data” field after the “picture_header” field.

29. An apparatus as claimed in claim 21, wherein said means (a) (d) are comprised in a first video processing apparatus, while means (e) and (f) are comprised in a second apparatus connected to the first apparatus for the transmission of said second bitstream.

30. An apparatus for performing steps (a)-(c) of claim 1 for transcoding a first bitstream in a first format to a second bitstream in a second format for transmission over a digital interface, the apparatus including means for deriving and embedding in said second bitstream additional information regarding the structure of said first bitstream in said first format.

31. An apparatus as claimed in claim 30, wherein the additional information specifies which pictures encoded as intra-coded pictures in said second bitstream were not encoded as intra-coded pictures in said first bitstream.

32. An apparatus for performing steps (e) and (f) of claim 1 transcoding a second bitstream in a second format to a third bitstream in a third format wherein said second bitstream in a second format is received over a digital interface and transcoded into said third bitstream in said third format using information embedded in said second bitstream, said information defining the structure of a first bitstream in a first format from which the second bitstream was previously derived.

33. An apparatus as claimed in claim 32, wherein the third bitstream includes both inter-coded and intra-coded pictures and wherein the additional information is used to control which pictures, encoded as intra-coded pictures in said second bitstream, should be encoded as intra-coded pictures in said third bitstream in preference to other pictures also encoded as intra-coded pictures in said second bitstream.

34. An apparatus as claimed in claim 21, further comprising means for recording of said third bitstream on a record carrier in accordance with any of the methods set forth above.

35. An apparatus for generating an electronic signal representing a video stream encoded in an intermediate format as a series of intra-coded pictures, the signal further comprising encoded additional historical functional information indicating the picture type and picture sequence from which said intra-coded pictures were derived.

36. An apparatus as claimed in claim 35 wherein the electronic signal has encoded said historical functional information in user data fields of a standard video data format.
